(19) United States
(12) Patent Application Publication
(10) Pub. No.: US 2015/0104200 A1
(43) Pub. Date: Apr. 16, 2015

(54) IMAGE FORMING APPARATUS AND OPERATION METHOD THEREOF

(71) Applicant: Sharp Kabushiki Kaisha, Osaka (JP)

(72) Inventor: Manabu MATSUMOTO, Osaka-shi (JP)

(21) Appl. No.: 14/489,610

(22) Filed: Sep. 18, 2014

(30) Foreign Application Priority Data
Oct. 10, 2013 (JP) 2013-213016

(51) Int. Cl. G03G 15/08; G03G 15/00

(52) U.S. Cl. CPC G03G 15/0863; G03G 15/553
USPC 399/12; 399/27; 399/80

(57) ABSTRACT

A consumable component containing a consumable supply used at the time of image formation is detachably mounted on an image forming apparatus. The image forming apparatus includes an image forming unit for forming an image, a storage for storing identification information of the mounted consumable component, and a detecting unit for detecting remaining amount of the consumable supply. When removal and mounting of a consumable component is detected while the remaining amount of the consumable supply is not lower than a prescribed value (YES at step S1070), the image forming apparatus compares the identification information obtained from the mounted consumable component with the identification information stored in the storage, and thereby determines whether the mounted consumable component corresponds to the identification information stored in the storage (step S1090). If the determination is negative, the image forming apparatus controls the image forming unit such that the image forming operation is inhibited.

### CROSS-REFERENCE TO RELATED APPLICATION

This nonprovisional application claims priority under 35 U.S.C. §119(a) on Patent Application No. 2013-213016 filed in Japan on Oct. 10, 2013, the entire contents of which are hereby incorporated by reference.

### BACKGROUND OF THE INVENTION

1. Field of the Invention

The present invention relates to an image forming apparatus and operation method thereof and, more specifically, to a technique of notifying time for replacement of a consumable component.

2. Description of the Background Art

In an electrophotographic image forming apparatus, it is common to use a toner cartridge containing toner, which is detachably mounted to the main body of the apparatus. The toner in toner cartridge is consumed as image forming processes proceed in the image forming apparatus. When the amount of toner remaining in the cartridge becomes small, the cartridge is replaced by a new one.

The remaining amount of toner is determined, for example, by a toner count determining the used amount of toner in accordance with the number of prints. When the toner count reaches a prescribed value, the image forming apparatus detects low toner, and displays a message urging replacement of cartridge on a display unit such as a display screen. Noticing such a message, a user opens a cover of the apparatus body, takes out the low-toner cartridge, mounts a new cartridge full of toner and closes the cover. When the cartridge is replaced in this manner, the toner count is reset to the initial value.

Japanese Patent Laying-Open No. 2003-241584 (hereinafter referred to as '584 Reference) discloses an image forming apparatus detecting replacement of a cartridge, using an attachment-and-removal sensor that detects whether a cartridge is correctly attached. According to '584 Reference, changes in the detection signal from the attachment-and-removal sensor are monitored to detect whether the cartridge is replaced. Here, even if a cartridge is not replaced but simply removed and mounted again, the sensor falsely detects a replacement of cartridge. Therefore, in the technique of '584 Reference, every time a replacement of cartridge is detected, an inquiry is made, asking the user if the toner count may be reset. After receiving information input by the user that reset of the counter is permitted, the image forming apparatus resets the counter.

In the image forming apparatus described in '584 Reference, an inquiry asking whether a reset is permitted is made even when a cartridge is simply pulled out and inserted again and not replaced, and the user must enter the information each time. Therefore, the image forming apparatus of '584 Reference requires a complicated operation.

In view of the foregoing, Japanese Patent Laying-Open No. 2010-282227 (hereinafter referred to as '227 Reference) proposes an image forming apparatus that makes an inquiry only when it is highly likely that the cartridge is replaced. A cartridge is provided with a toner agitator member for agitating the toner inside the cartridge. The image forming apparatus has a function of detecting torque when the agitator member rotates. The image forming apparatus further detects a cover opening/closing operation of the cover which is opened/closed when a cartridge is mounted/removed, and detects a change in torque before and after the opening/closing operation of the cover. When a low-toner cartridge is replaced by a new, full cartridge, the torque after the cover opening/closing operation becomes higher than before. According to '227 Reference, whether it is highly likely that the cartridge has been replaced is determined based on such a change in torque. If it is determined highly likely that the cartridge has been replaced, the image forming apparatus stops image forming operation and inquires the user if the newly mounted cartridge is a used cartridge. After receiving an input in response to the inquiry, the image forming operation is resumed.

As described above, in the conventional image forming apparatuses, if the toner in a currently used toner cartridge attains low (attains to a near-end state), a message urging replacement of the cartridge is displayed. If the toner is depleted (attains to an end state), image forming process cannot be executed and, hence, the image forming apparatus warns the user to prepare for a new toner cartridge before the currently used cartridge reaches the end state. The user prepares a new cartridge and, generally, replaces the cartridge in accordance with the displayed message. It is the case, however, that the currently used cartridge is still usable. From the viewpoint of efficient resource use, it is desirable to use up the toner.

The objects of '584 and '227 References are not to replace cartridges after the toner is used up. In the image forming apparatuses described in '584 and '227 References, the user can easily replace the cartridge before the toner is used up. Therefore, it is difficult to efficiently use resource with the techniques disclosed in '584 and '227 References.

As a solution to such a problem, conventionally, a technique of preventing replacement of a cartridge before the toner is used up by means of a mechanical lock mechanism has been known. Such a mechanical lock mechanism, however, is complicated. Therefore, the structure becomes complicated and the manufacturing cost increases.

### SUMMARY OF THE INVENTION

Therefore, it is desirable to provide an image forming apparatus and its operation method that enable efficient use of resource with a simple structure and at a low cost.

### Solution to Problem

According to a first aspect, the present invention provides an image forming apparatus, including: an image forming unit configured to form an image; a mounting unit configured to detachably mount a consumable component containing a consumable supply used when an image is formed by the image forming unit; a storage configured to store identification information for uniquely identifying the mounted consumable component; a detecting unit configured to detect a remaining amount of the consumable supply in the mounted consumable component; a determining unit, configured to obtain, responsive to a detection of removal and mounting of a consumable component while the remaining amount of the consumable supply is not lower than a prescribed value, from the mounted consumable component, the identification information of the mounted consumable component and to compare the obtained identification information with the identification information stored in the storage, and thereby to determine whether the mounted consumable component corresponds to the identification information stored in the storage; and an inhibiting unit, configured to control the image forming unit such that an image forming operation is inhibited, responsive to a negative result of determination by the determining unit.

A consumable component containing a consumable supply used for image formation is detachably mounted on the image forming apparatus. The image forming apparatus stores identification information of the mounted consumable component in a storage, to identify the consumable component that is currently used. The image forming apparatus detects the remaining amount of the consumable supply in the mounted consumable component and, if removal/mounting of the consumable component is detected while the remaining amount of the consumable supply is not lower than a prescribed value, determines whether the mounted consumable component corresponds to the identification information stored in the storage. Specifically, if removal and mounting of a consumable component take place while the remaining amount of the consumable supply is not lower than the prescribed value, the image forming apparatus determines if the newly mounted consumable component is the consumable component that has been used by that time. If the mounted consumable component is not the consumable component that has been used, the image forming apparatus controls the image forming unit such that the image forming operation is inhibited.

In this manner, if the consumable component is removed while the remaining amount of the consumable supply is not lower than the prescribed value, that is, not a small amount of the consumable supply still remains, and a different consumable component (for example, a brand-new consumable component) is mounted, the image forming apparatus inhibits the image forming operation. Image formation cannot be done unless the consumable supply is used up before replacing the consumable component. Therefore, replacement of a consumable component before using up the consumable supply can easily be prevented. Further, in the image forming apparatus, mechanical lock mechanism is not used to prevent replacement of a consumable component before using up the consumable supply. Therefore, the image forming apparatus of the present invention enables efficient use of resource with a simple structure and at a low cost.

Preferably, the image forming apparatus further includes: a consumable component determining unit, configured to obtain, responsive to a detection of removal and mounting of a consumable component while the image forming operation is inhibited, the identification information from the mounted consumable component and to compare the obtained identification information with the identification information stored in the storage, and thereby to determine whether the mounted consumable component corresponds to the identification information stored in the storage; and an executing unit, configured to selectively cancel or maintain the inhibited state, depending on the result of determination by the consumable component determining unit.

More preferably, the image forming apparatus further includes a notifying unit, configured to give a notice urging replacement of the consumable component, when the remaining amount of the consumable supply becomes lower than the prescribed value.

More preferably, the image forming apparatus further includes: a display unit configured to display information; and a display control unit configured to control the display unit such that responsive to the inhibiting unit inhibiting the image forming operation of the image forming unit, the display unit displays a warning message urging mounting of the consumable component corresponding to the identification information stored in the storage.

More preferably, the image forming apparatus further includes: an authentication unit, configured to execute an authentication process for a user having an administrator authority; a receiving unit, configured to receive a cancelling operation for cancelling the image forming operation inhibited state, by the user having the administrator authority authenticated by the authentication unit; and a cancelling unit, configured to cancel the image forming operation inhibited state, responsive to the receiving unit receiving the cancelling operation.

More preferably, the image forming apparatus further includes a setting unit configured to set whether the process by the inhibiting unit is to be executed or not; wherein the receiving unit receives the cancelling operation of cancelling the image forming operation inhibited state, when a setting operation by the user having the administrator authority is received.

More preferably, the image forming apparatus further includes: a rewriting unit, configured to rewrite, responsive to cancellation of the image forming operation inhibited state by the reception of the cancelling operation, the identification information stored in the storage with the identification information of the mounted consumable component; and a setting control unit, responsive to the rewriting unit rewriting the identification information, controlling setting of the setting unit such that the process by the inhibiting unit is executed.

More preferably, the mounting unit includes a cartridge mounting unit configured to detachably mount a cartridge containing toner.

According to a second aspect, the present invention provides a method of operating an image forming apparatus including: an image forming unit configured to form an image; a mounting unit configured to detachably mount a consumable component containing a consumable supply used when an image is formed by the image forming unit; and a storage configured to store identification information for uniquely identifying the mounted consumable component. The method of operation includes the steps of: detecting a remaining amount of the consumable supply in the mounted consumable component; in response to a detection of removal and mounting of a consumable component while the remaining amount of the consumable supply is not lower than a prescribed value, obtaining, from the mounted consumable component, the identification information of the mounted consumable component, and comparing the obtained identification information with the identification information stored in the storage, and thereby determining whether the mounted consumable component corresponds to the identification information stored in the storage; and controlling the image forming unit such that an image forming operation is inhibited, in response to a negative result of determination at the determining step.

As described above, the present invention provides an image forming apparatus and operation method thereof that enable efficient use of resource with a simple structure and at a low cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an appearance of an image forming apparatus in accordance with a first embodiment of the present invention.

FIG. 2 is a control block diagram showing a hardware configuration of the image forming apparatus shown in FIG. 1.

FIG. 3 is a flowchart representing a control structure of a program executed by the image forming apparatus shown in FIG. 1.

FIG. 4 is a flowchart representing a control structure of a program executed by the image forming apparatus shown in FIG. 1.

FIG. 5 is a detailed flow of steps S1010, S1080 and S1180 of FIG. 3 and step S1130 of FIG. 4.

FIG. 6 is a detailed flow of step S1200 of FIG. 3.

FIG. 7 shows an example of a screen image displaying a message asking preparation of a toner cartridge.

FIG. 8 shows an example of a screen image showing a warning message displayed when a different toner cartridge is mounted.

FIG. 9 shows an example of a screen image showing a warning message displayed when toner in a toner cartridge is used up.

FIG. 10 is a control block diagram showing a hardware configuration of an image forming apparatus in accordance with a second embodiment of the present invention.

FIG. 11 is a flowchart representing a control structure of a program executed by the image forming apparatus shown in FIG. 10.

FIG. 12 is a flowchart representing a control structure of a program executed by the image forming apparatus shown in FIG. 10.

FIG. 13 shows an example of a screen image for authenticating a user having an administrator authority.

FIG. 14 shows an example of a screen image for entering an authentication password.

FIG. 15 shows an example of a screen image for system settings.

### DESCRIPTION OF THE PREFERRED EMBODIMENTS

In the following description, the same components are denoted by the same reference characters. Their functions and names are also the same. Therefore, detailed description thereof will not be repeated.

### First Embodiment

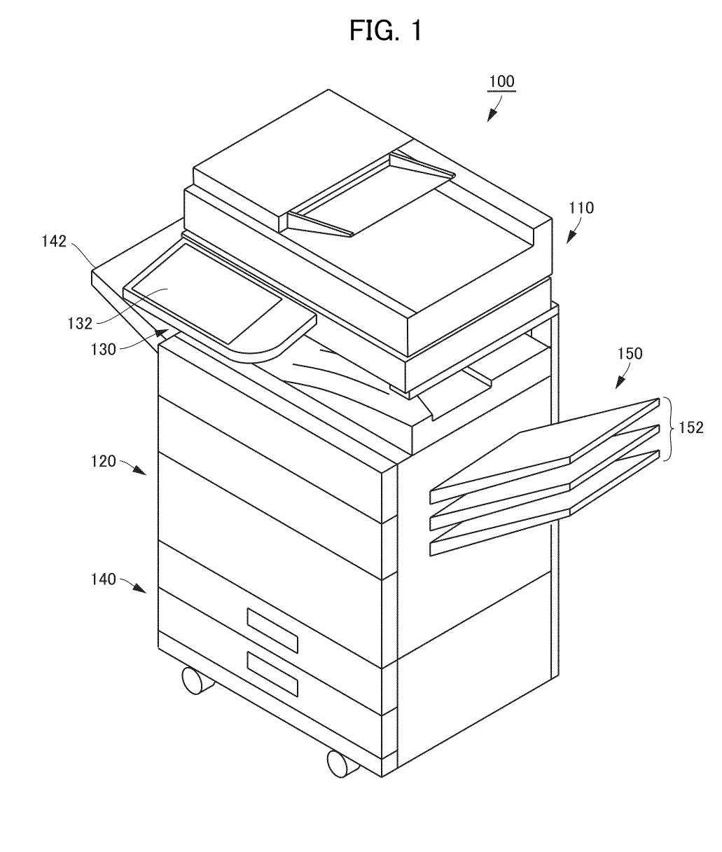

Referring to FIG. 1, an image forming apparatus 100 in accordance with the present embodiment is an MFP (Multifunction Peripheral) having copy, printing and other functions. Image forming apparatus 100 has a so-called laser type (electrophotographic) printing function, using a laser beam for exposure. In the laser type image forming apparatus, toner is used as a developer at the time of image formation. Image forming apparatus 100 is a cartridge type image forming apparatus, and the toner as the developer is supplied by a toner cartridge. Image forming apparatus 100 is provided with a cartridge mounting unit for detachably mounting a toner cartridge containing toner. The toner in the toner cartridge is consumable supply used at the time of image formation and, therefore, when the toner runs out, the toner cartridge that has been mounted is removed and a new toner cartridge (brand-new toner cartridge) is mounted. Since replenishment (supply) of toner to image forming apparatus 100 is realized by the replacement of toner cartridge, the toner cartridge itself is also a consumable component.

In the present embodiment, when a toner cartridge still containing toner is removed and replaced by a new toner cartridge, image forming apparatus 100 recommends the user to use up the toner first and then to replace with the new cartridge, and inhibits execution of an image forming process with the newly mounted cartridge. Specifically, image forming apparatus 100 inhibits replacement of a toner cartridge before the toner therein is used up.

Image forming apparatus 100 includes a document reading unit 110, an image forming unit 120, an operation unit 130, a paper feed unit 140, a manual paper feed tray 142 and a paper discharge unit 150. Operation unit 130 includes a touch-panel display 132. Touch-panel display 132 includes a display panel implemented, for example, by a liquid crystal panel, and a touch-panel placed on the display panel, for detecting a touched position. A plurality of paper discharge trays 152 are provided at paper discharge unit 150.

[Hardware Configuration]

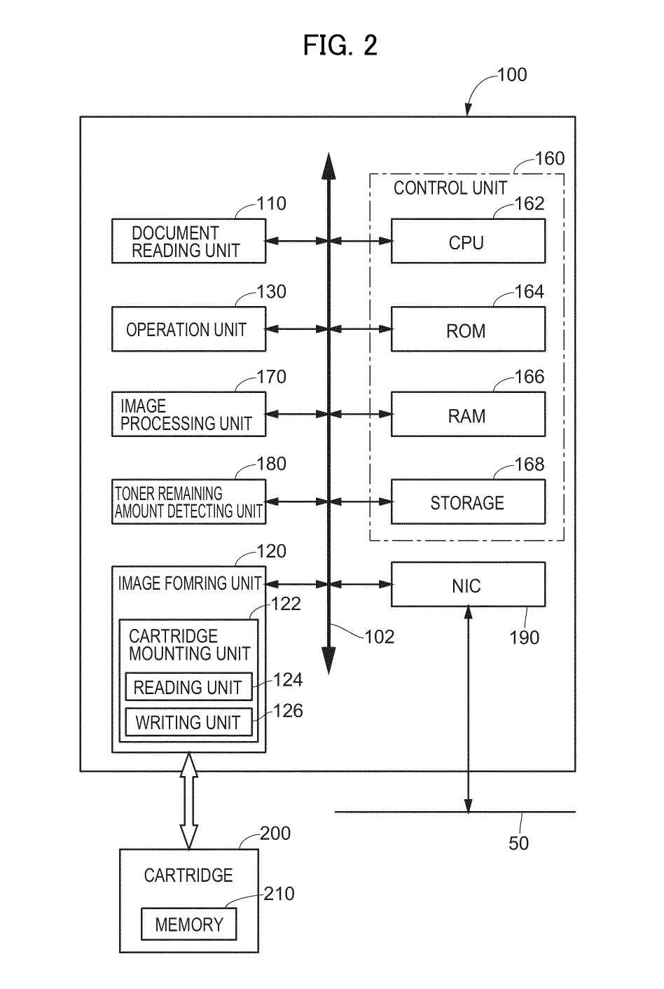

Referring to FIG. 2, in addition to document reading unit 110, image forming unit 120, operation unit 130 and the like, image forming apparatus 100 includes a control unit 160, an image processing unit 170, a toner remaining amount detecting unit 180 and an NIC (Network Interface Card) 190.

Control unit 160 is substantially a computer and it includes a CPU (Central Processing Unit) 162 for overall control of image forming apparatus 100, an ROM (Read Only Memory) 164 for storing programs and the like, an RAM (Random Access Memory) 166 as a volatile storage device, and a storage 168. Storage 168 is a non-volatile storage device that retains data even when power supply is stopped, and it is, for example, a hard disk drive or a flash memory. A bus line 102 is connected to CPU 162, and ROM 164, RAM 166 and storage 168 are electrically connected to bus line 102.

CPU 162 executes various computer programs (hereinafter also simply referred to as “programs”) in accordance with instructions from operation unit 130 and the like, and thereby executes operations of various components in image forming apparatus 100 as well as other desired processes including communication with an external device such as an information processing apparatus (not shown). The various computer programs mentioned above are stored beforehand in ROM 164 or storage 168, and at the time of execution of a desired process, the program or programs are read from ROM 164 or storage 168 and transferred to RAM 166. CPU 162 reads and interprets a program instruction from an address in RAM 166 designated by a value stored in a register, which is referred to as a program counter, not shown, provided in CPU 162. Further, CPU 162 also reads data necessary for an operation from an address designated by the read instruction, and executes an operation corresponding to the instruction on the data. The result of execution is also stored at an address designated by the instruction, for example, in a register in CPU 162 or storage 168.

In addition to the programs for realizing general operations of image forming apparatus 100, ROM 164 or storage 168 stores a program for realizing the process for inhibiting replacement of a toner cartridge before the toner is used up, as will be described later. The program is provided from an information processing apparatus or the like through a network 50 and NIC 190. The program may be provided by a storage medium such as a DVD on which the program is recorded. Specifically, a DVD as a recording medium for the computer program may be loaded on a DVD drive (not shown) in image forming apparatus 100, and the program may be read from the DVD and installed in storage 168. Storage 168 further stores various data including image data. ROM 164 or storage 168 also stores an identification number (for example, device number such as manufacturer's serial number) for identifying the image forming apparatus itself.

To bus line 102, document reading unit 110, image forming unit 120, operation unit 130, image processing unit 170, toner remaining amount detecting unit 180 and NIC 190 are also electrically connected.

Document reading unit 110 includes a scanner and a CCD (Charge Coupled Device) line sensor (both not shown). The scanner irradiates an image-bearing surface of a document placed on a platen (not shown) manually or by an automatic document feeder (not shown) with light from a light source (not shown), and thereby obtains reflection light and forms an image of the obtained reflection light on the CCD line sensor, and in this manner it scans a document while moving the light source. The CCD line sensor executes photo-electric conversion of the formed reflection light image successively, and outputs the result as image data to image processing unit 170. Specifically, when the document is to be copied or scanned, document reading unit 110 reads image information by the scanner from the document placed on the platen, converts the read image information to electric signals by the CCD line sensor, and outputs the resulting image data to image processing unit 170.

Image processing unit 170 includes an MPU (Micro Processing Unit, not shown). Image processing unit 170 performs various processes including a prescribed image processing such as rasterization on the image data received from document reading unit 110, information processing unit or the like, and thereby creates print data of a prescribed tone, which is output to image forming unit 120.

Image forming unit 120 realizes monochrome or color printing of an image represented by the image data on recording paper, and it includes, for example, a photoreceptor drum, a charger, a laser scanning unit (LSU), a developer, a transfer device, a cleaning device, a fixing device and a neutralizer. Image forming unit 120 includes, for example, a conveyer path, and recording paper fed from paper feed unit 140 is conveyed along the conveyer path. Paper feed unit 140 picks up sheets of recording paper contained in a paper cassette (not shown) or placed on manual paper feed tray 142 one by one and feeds the sheets of recording paper to the conveyer path of image forming unit 120. While the sheet of recording paper is fed along the conveyer path of image forming unit 120, the sheet passes between the photoreceptor drum and the transfer device, and further through the fixing device, whereby printing is done on the sheet of recording paper.

The photoreceptor drum rotates in one direction, and its surface is cleaned by the cleaning device and the neutralizer and thereafter uniformly charged by the charger. The laser scan unit modulates the laser beam in accordance with the image data as the object of printing, and repeatedly scans the surface of the photoreceptor drum with the laser beam in a main scanning direction, whereby an electrostatic latent image is formed on the surface of photoreceptor drum. The developer supplies toner to the surface of photoreceptor drum to develop the electrostatic latent image, and thus forms a toner image on the surface of photoreceptor drum. The transfer device transfers the toner image on the surface of photoreceptor drum on the sheet of recording paper passing between the transfer device and the photoreceptor drum.

The fixing device includes a heat roller for heating the sheet of recording paper and a pressure roller for pressing the sheet of recording paper. The recording paper is heated by the heat roller and pressed by the pressure roller, whereby the toner image that has been transferred to the recording paper is fixed on the recording paper. The sheet of recording paper discharged from the fixing device (printed sheet) is discharged to paper discharge tray 152.

Image forming unit 120 includes a cartridge mounting unit 122 to which a toner cartridge 200 is mounted. Toner cartridge 200 has a non-volatile memory 210. Non-volatile memory 210 stores information such as identification information for uniquely identifying the toner cartridge. The identification information of toner cartridge includes an identification number unique to the image forming apparatus 100 (for example, device number such as the manufacturer's serial number) and a management serial number (for example, a number indicating what number cartridge it is) managed by image forming apparatus 100.

In the present embodiment, a brand-new toner cartridge does not have the identification information, and the identification information of the brand-new toner cartridge is generated by image forming apparatus 100. At the time of replacement of toner cartridges, image forming apparatus 100 writes identification information of the brand-new toner cartridge to the non-volatile memory. Cartridge mounting unit 122 includes a sensor (not shown) detecting a cartridge mounted state, an information reading unit 124 reading (obtaining) information stored in the non-volatile memory of the mounted toner cartridge, and an information writing unit 126 writing information to the non-volatile memory of the mounted toner cartridge. The identification information of the currently used toner cartridge is also stored in storage 168 of image forming apparatus 100 when the identification information is generated.

Toner remaining amount detecting unit 180 detects the remaining amount of toner of the mounted toner cartridge. Toner remaining amount detecting unit 180 determines (detects) the remaining amount of toner, for example, by a toner count determining the used amount of toner in accordance with the number of prints. When the toner count reaches a prescribed value, toner remaining amount detecting unit 180 outputs, to control unit 160, a signal indicating that the remaining amount of toner is lower than the prescribed value. In the present embodiment, when toner remaining amount detecting unit 180 detects zero toner as the prescribed value (when it detects the end state), it outputs a signal indicating detection of the end state to control unit 160. It is also possible for toner remaining amount detecting unit 180 to detect that the remaining amount of toner is small (near-end state). When toner remaining amount detecting unit 180 detects the near end state, it outputs a signal indicating detection of the near-end state to control unit 160.

NIC 190 provides an interface with network 50. Image forming apparatus 100 is capable of data communication in accordance with a prescribed communication protocol with an information processing apparatus or the like on network 50, through NIC 190. Image forming apparatus 100 can receive instruction signals instructing execution of various processes such as a print job, from the information processing apparatus through NIC 190.

Operation unit 130 includes touch-panel display 132 including the display panel and the touch-panel as described above. The display panel presents various pieces of information including the information related to the state of image forming apparatus 100 and states of various processes. Touch-panel display 132 also provides an interactive operation interface (user interface) to the user. The interactive operation interface receives user instructions related to the overall operation of image forming apparatus 100 through the touch-panel, displays the contents of instructions on the display panel, and outputs control signals in accordance with the instructions to control unit 160 or image processing unit 170.

[Software Configuration]

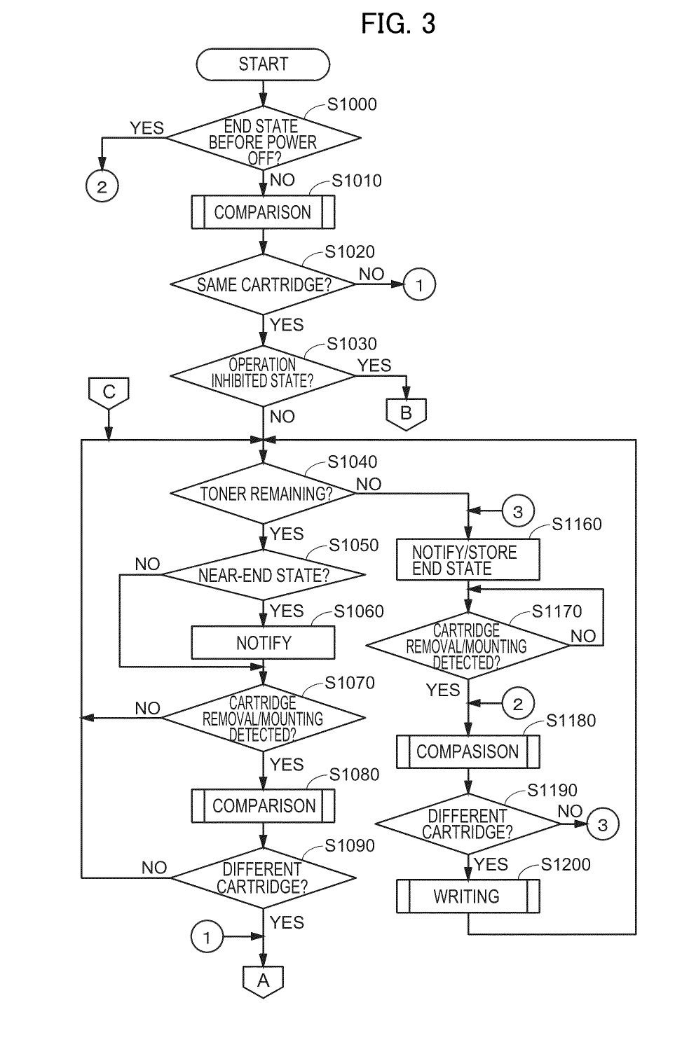

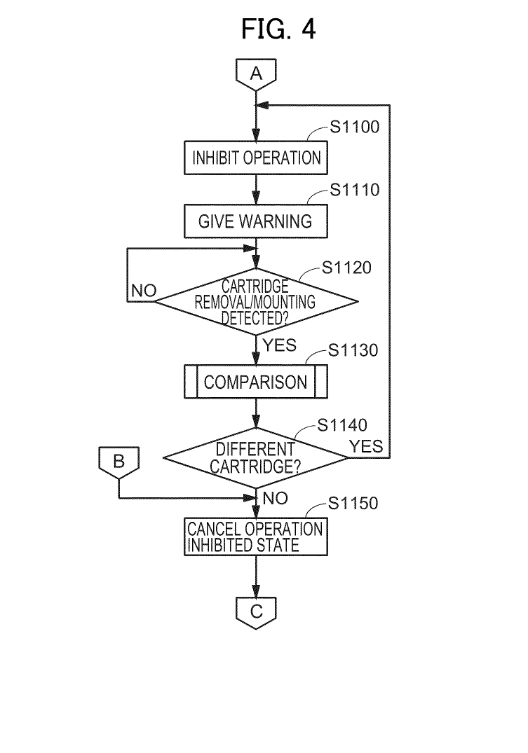

Referring to FIGS. 3 and 4, a control structure of a program executed by image forming apparatus 100 to inhibit replacement of a toner cartridge before using up the toner will be described.

The replacement of toner cartridges takes place when the power of image forming apparatus 100 is on or off. When the power of image forming apparatus 100 is on, image forming apparatus 100 detects removal/mounting of toner cartridge from an output of the sensor detecting the state of mounting of toner cartridge, or from an output of the sensor detecting the opening/closing operation of a cover (a cover opened/closed when a toner cartridge is removed/mounted, such as a front door of the apparatus body) of cartridge mounting unit 122. The removal/mounting of toner cartridge means that a currently mounted toner cartridge is removed and then a toner cartridge is mounted, and it may be the same toner cartridge or a different toner cartridge that is mounted.

When the power of image forming apparatus 100 is off, the sensor detecting the state of mounting of toner cartridge and the sensor detecting the opening/closing operation of a cover are not operating. Therefore, image forming apparatus 100 cannot detect removal/mounting of a toner cartridge. Here, image forming apparatus 100 assumes that a toner cartridge has been removed/mounted while the power is off, and detects the removal/mounting when the power is turned on. In the following, it is assumed that the identification information of the currently used toner cartridge is stored in storage 168 of image forming apparatus 100.

The program starts when the power of image forming apparatus 100 is turned on. Referring to FIG. 3, the program includes a step S1000 of determining whether the toner cartridge was in a state of zero toner (end state) before the power was turned off (in the immediately preceding operation) and branching the control flow depending on the result of determination. As will be described later, if toner remaining amount detecting unit 180 detects that the remaining toner of the toner cartridge is in the end state, control unit 160 stores the end state in storage 168. At this step S1000, whether the toner remaining amount of toner cartridge was in the end state or not before the power was turned off is determined, depending on whether the end state is stored in storage 168 or not.

The program further includes: a step S1010, executed if it is determined that the state was not the end state before the power was turned off, of comparing the mounted toner cartridge with the toner cartridge that has been used, based on the stored identification information; a step S1020, executed after step S1010, of determining whether the mounted toner cartridge is the same as the toner cartridge that has been used, and branching the flow of control depending on the result of determination; a step S1030, executed if it is determined at step S1020 that the mounted toner cartridge is the same as the one that has been used, of determining whether the apparatus itself is in a state in which the image forming operation is inhibited (execution of image forming process is inhibited, hereinafter also referred to as “operation inhibited state”), and branching the flow of control depending on the result of determination; a step S1040, executed if it is determined at step S1030 that the apparatus is not in the operation inhibited state, of determining whether or not toner is left in the toner cartridge, and branching the flow of control depending on the result of determination; a step S1050, executed if it is determined at step S1040 that the toner is left in the toner cartridge, of determining whether the remaining amount of toner in the toner cartridge is in the near-end state, and branching the flow of control depending on the result of determination; and a step S1060, executed if it is determined at step S1050 that the remaining amount of toner in the toner cartridge is in the near-end state, of notifying the user of the near-end state.

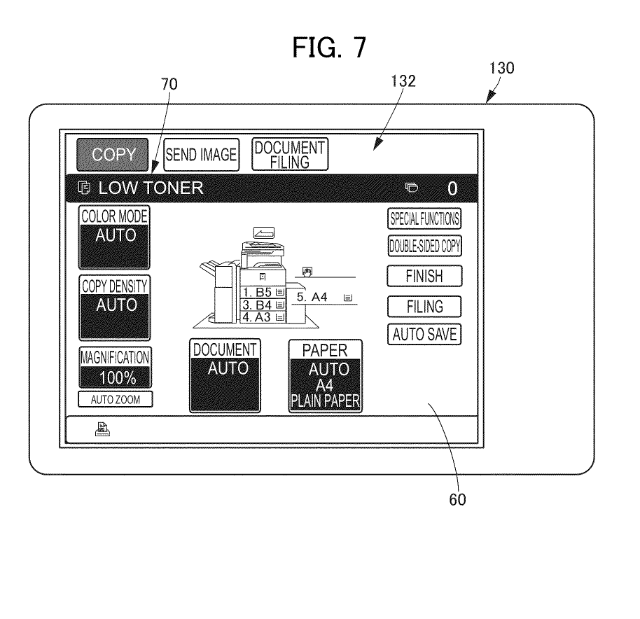

At step S1060, in order to notify the user that the remaining amount of toner in the toner cartridge is small (near-end state), a message requesting preparation of a new toner cartridge is displayed on touch-panel display 132. Referring to FIG. 7, a home screen image 60 is displayed on touch-panel display 132, and a message 70 “LOW TONER” is displayed on home screen image 60.

Again referring to FIG. 3, the program further includes: a step S1070, executed if it is determined at step S1050 that the remaining amount of toner in the toner cartridge is not in the near-end state or after step S1060, of determining whether or not removal/mounting of a toner cartridge has been detected, and branching the flow of control depending on the result of determination; a step S1080, executed if it is determined at step S1070 that the removal/mounting of a toner cartridge is detected, of comparing the mounted toner cartridge with the toner cartridge that has been used, based on the stored identification information; and a step S1090, executed after step S1080, of determining whether the mounted toner cartridge is the same as the toner cartridge that has been used, based on the result of comparison, and branching the flow of control depending on the result of determination. If it is determined at step S1070 that removal/mounting of a toner cartridge is not detected, or if it is determined at step S1090 that the mounted cartridge is the same as the one that has been used, the control returns to step S1040.

Referring to FIGS. 3 and 4, the program further includes: a step S1100, executed if it is determined at step S1020 or at step S1090 that the mounted toner cartridge is different from the toner cartridge that has been used, of controlling image forming unit 120 such that the image forming operation is inhibited; and a step S1110, executed after step S1100, of giving a warning to reinstate or place back the toner cartridge that has been used.

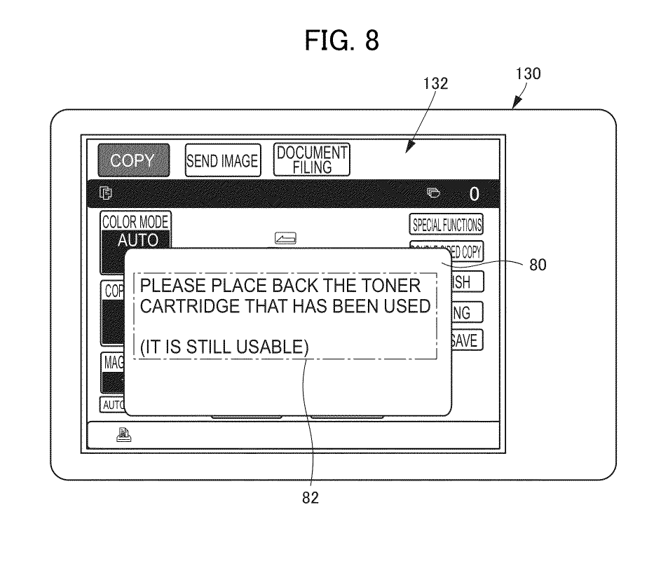

At step S1110, a warning screen image urging use of the toner cartridge that has been used is displayed on touch-panel display 132. Referring to FIG. 8, the warning screen image 80 includes a message area 82, on which a text “Please place back the toner cartridge that has been used (it is still usable)” is displayed. The warning screen image does not include any button that allows erasure of the message after the user reads it. Therefore, the warning screen image 80 cannot be erased by an operation by the user. Further, even after some time, the warning screen image 80 does not automatically disappear.

Referring to FIG. 4, the program further includes: a step S1120, executed after step S1110, of determining whether or not removal/mounting of a toner cartridge is detected and waits until the removal/mounting is detected; a step S1130, executed if it is determined at step S1120 that removal/mounting of a toner cartridge is detected, of comparing the mounted toner cartridge with the toner cartridge that has been used, based on the stored identification information; a step S1140, executed after step S1130, of determining whether or not the mounted toner cartridge is different from the toner cartridge that has been used, based on the result of comparison, and branching the flow of control depending on the result of determination; and a step S1150, executed if it is determined at step S1030 shown in FIG. 3 that the apparatus is in the operation inhibited state, or if it is determined at step S1140 that the mounted toner cartridge is not different from the toner cartridge that has been used, or it is the same toner cartridge, of cancelling the operation inhibited state and erasing the warning screen image 80. If it is determined at step S1140 that the mounted toner cartridge is different from the toner cartridge that has been used, the control returns to step S1100. When the process of step S1150 ends, the control returns to step S1040 shown in FIG. 3.

Again referring to FIG. 3, the program further includes: a step S1160, executed if it is determined at step S1040 that the toner is not left in the toner cartridge (end state), of notifying the user of the end state and storing the end state in storage 168; a step S1170, executed after step S1160, of determining whether or not removal/mounting of a toner cartridge is detected, and waits until the removal/mounting is detected; a step S1180, executed if it is determined at step S1000 that the toner was in the end state before the power was turned off, or if it is determined at step S1170 that the removal/mounting of a toner cartridge is detected, of comparing the mounted toner cartridge with the toner cartridge that has been used, based on the stored identification information; a step S1190, executed after step S1180, of determining whether the mounted toner cartridge is different from the toner cartridge that has been used, based on the result of comparison, and branching the flow of control depending on the result of determination; and a step S1200, executed if it is determined at step S1190 that the mounted toner cartridge is different from the toner cartridge that has been used, of writing the identification information of the mounted toner cartridge to the non-volatile memory of the mounted toner cartridge and to the storage 168. If it is determined at step S1190 that the mounted toner cartridge is not different from the one that has been used, or it is the same toner cartridge, the control returns to step S1160. When the process of step S1200 ends, the control returns to step S1040.

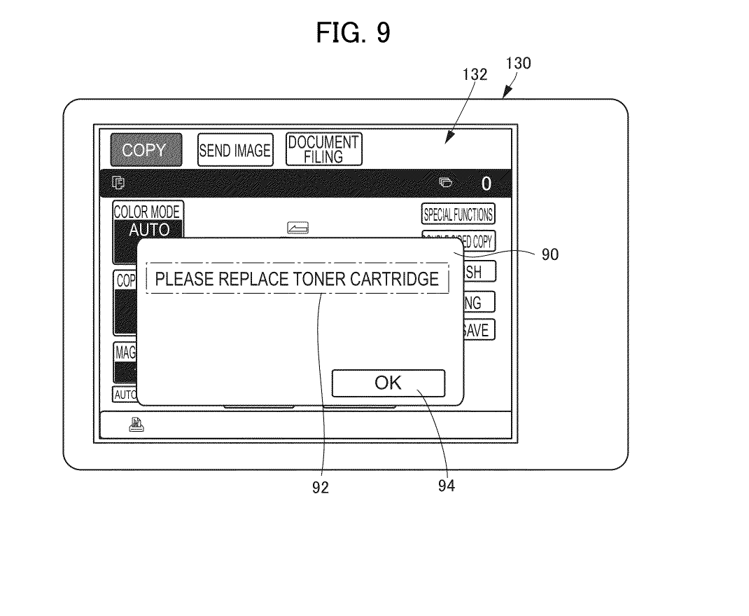

At step S1160, in order to notify the user that the toner in the toner cartridge is used up (end state), a warning screen image including a message urging replacement of toner cartridge is displayed on touch-panel display 132. Referring to FIG. 9, the warning screen image 90 includes a message area 92 on which a text “PLEASE REPLACE TONER CARTRIDGE” is displayed, and an OK button 94 allowing erasure of the message after reading. Receiving an operation of OK button 94 by the user, control unit 160 controls the display of touch-panel display 132 so that the warning screen image 90 is erased. Further, control unit 160 sets a flag indicating end state or not to “1” (end state), so that the end state is stored in RAM 166 or storage 168.

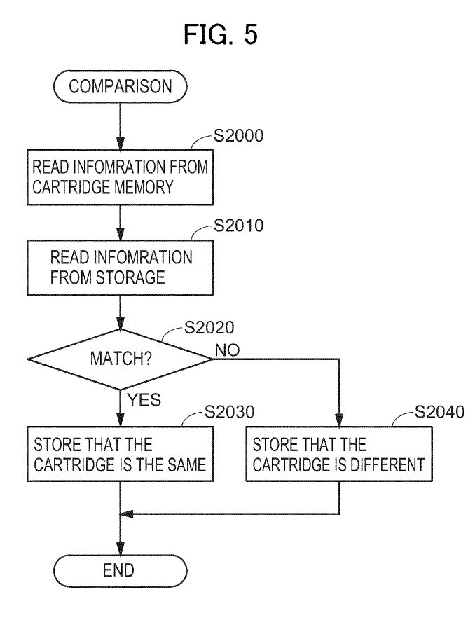

FIG. 5 is a detailed flow of steps S1010, S1080 and S1180 of FIG. 3 and step S1130 of FIG. 4. Referring to FIG. 5, the routine includes: a step S2000 of controlling an information reading unit 124 of cartridge mounting unit 122 such that identification information of the mounted toner cartridge is read from the non-volatile memory of the toner cartridge; a step S2010, executed after step S2000, of reading the identification information of the toner cartridge that has been used, from the storage 168 of the apparatus; a step S2020, executed after step S2010, of comparing the identification information read from the non-volatile memory of the mounted toner cartridge with the identification information of the toner cartridge that has been used read from the storage 168, and determining whether these pieces of information match, and branching the flow of control depending on the result of determination; a step S2030, executed if it is determined at step S2020 that these pieces of information match, of storing that the mounted toner cartridge is the same as the toner cartridge that has been used; and a step S2040, executed if it is determined at step S2020 that the pieces of information do not match, of storing that the mounted toner cartridge is not the same as the toner cartridge that has been used. When the process of step S2030 or S2040 ends, the routine ends.

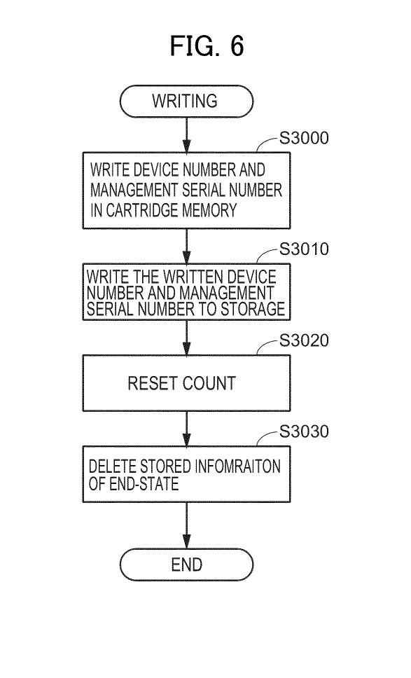

FIG. 6 is a detailed flow of step S1200 of FIG. 3. Referring to FIG. 6, the routine includes: a step S3000 of generating identification information consisting of the identification number of the apparatus (for example, device number) and a management serial number, and controlling information reading unit 124 of cartridge mounting unit 122 such that the generated identification information is written to the non-volatile memory of the toner cartridge; a step S3010, executed after step S3000, of writing the identification information same as that written to the non-volatile memory to storage 168 of the apparatus; a step S3020, executed after step S3010, of resetting the toner count; and a step S3030, executed after step S3020, of cancelling the end state stored in RAM 166 or storage 168 and ending the routine.

At step S3010, if the identification information has already been stored in storage 168, the stored identification information is overwritten by the same identification information as that written to the non-volatile memory. If no identification information has been stored in storage 168 (the mounted toner cartridge is the first toner cartridge that is mounted on the image forming apparatus 100), the same identification information as that written to the non-volatile memory is written to storage 168. At step S3030, by way of example, the flag indicating the end state is set to “0” (not the end state) and the storage of end state is thus cancelled.

[Operation]

Image forming apparatus 100 in accordance with the present embodiment operates in the following manner. In the following, of the operations of image forming apparatus, only those related to the present invention will be described. Other operations are the same as those of the conventional image forming apparatuses. In the following, description will be given separately for the replacement of toner cartridge when the power is on and when the power is off.

<Replacement of Toner Cartridge when the Power is on>

Image forming apparatus 100 has the identification information of the toner cartridge that is currently used, stored in storage 168. Image forming apparatus 100 executes a printing process (image forming process) such as copy-printing. The toner in the toner cartridge is consumed by the printing process. Toner remaining amount detecting unit 180 detects the remaining amount of toner in the toner cartridge that is currently used, and if it detects that the remaining amount of toner in the toner cartridge is low (detects near-end state), it outputs a signal indicating detection of the near-end state to control unit 160. Detecting the near-end state from the signal output from toner remaining amount detecting unit 180 (YES at step S1040 and YES at step S1050 of FIG. 3), control unit 160 notifies the user that the toner is low (step S1060). By way of example, control unit 160 displays a message that the toner is low, on touch-panel display 132. Referring to FIG. 7, on a part of home screen image 60 displayed on touch-panel display 132, a message 70 of “LOW TONER” is displayed.

Noticing the message, the user prepares a new toner cartridge (brand-new toner cartridge) and replaces the toner cartridge with the new one. Image forming apparatus 100 detects the removal/mounting of the toner cartridge from an output of, for example, the sensor detecting an opening/closing operation of the cover (YES at step S1070). When a toner cartridge is mounted, image forming apparatus 100 reads the identification information from the non-volatile memory of the toner cartridge (step S2000 of FIG. 5). Since no identification information is stored in the non-volatile memory of the brand-new toner cartridge, when the brand-new toner cartridge is mounted, image forming apparatus 100 recognizes that no identification information is stored.

Control unit 160 reads the identification information stored in storage 168 (identification information of the toner cartridge that has been used) (step S2010), and compares it with the identification information read from the toner cartridge, and thereby determines whether the mounted toner cartridge is the same as the toner cartridge that has been used. If the brand-new toner cartridge is mounted, control unit 160 determines that it is different from the toner cartridge that has been used (NO at step S2020), and stores the fact that it is a different cartridge, in RAM 166 or storage 168 (step S2040). If it is determined that the mounted toner cartridge is not the one that has been used (YES at step S1090), the control unit 160 control image forming unit 120 such that the apparatus is set to the operation inhibited state (step S1100 shown in FIG. 4). Here, control unit 160 causes touch-panel display 132 to display the warning screen image urging that the toner cartridge that has been used (the one used before replacement) should be placed back, instead of the newly mounted toner cartridge (step S1110). Referring to FIG. 8, the warning message “Please place back the toner cartridge that has been used (it is still usable)” is displayed on warning screen image 80. The warning screen image 80 is kept displayed until the operation inhibited state is cancelled. While the image forming apparatus is in the operation inhibited state, no operation of buttons on operation unit 130 is received and even when the user operates operation unit 130, the apparatus does not execute the image forming process.

Assume that in accordance with the message of warning screen image 80, the user puts the toner cartridge that has been used back to the mounting unit. Detecting the removal/mounting of a toner cartridge (YES at step S1120), image forming apparatus 100 executes the process of comparing the mounted toner cartridge (step S1130). If it is determined that the mounted toner cartridge is the same as the toner cartridge that has been used, or it is determined that the toner cartridge that has been used until immediately before the replacement is returned (NO at step S1140), image forming apparatus 100 (control unit 160) cancels the operation inhibited state, and warning screen image 80 is erased (step S1150). When the operation inhibited state is cancelled and the warning screen image 80 is erased, the apparatus resumes the state that allows image formation process.

When the toner cartridge that has been used is thus used continuously and when the toner in the toner cartridge is used up, toner remaining amount detecting unit 180 detects the end state. Toner remaining amount detecting unit 180 outputs a signal indicating detection of the end state to control unit 160. Detecting the end state from the signal output from toner remaining amount detecting unit 180 (NO at step S1040 of FIG. 3), control unit 160 notifies the user that the toner is used up (step S1160). By way of example, control unit 160 causes touch-panel display 132 to display a warning screen image including a message that the toner is empty (a message urging replacement of toner cartridge). Referring to FIG. 9, a message “PLEASE REPLACE TONER CARTRIDGE” is displayed on warning screen image 90. When the user operates OK button 94, the warning screen image 90 is erased. Further, when the end state is detected, control unit 160 stores the end state in RAM 166 or storage 168 (step S1160).

Thereafter, when a brand-new toner cartridge is mounted, image forming apparatus 100 generates identification information consisting of the identification number (for example, device number) of itself and a management serial number. The generated identification number is a piece of information for identifying the newly mounted brand-new toner cartridge. Image forming apparatus 100 writes the generated identification information to the non-volatile memory of the toner cartridge (step S3000 of FIG. 6), and also writes the same identification information to storage 168 (step S3010). Image forming apparatus 100 recognizes the toner cartridge corresponding to the identification information written in storage 168 as the toner cartridge that is being used. When the process of writing the identification information ends, image forming apparatus resets the toner count (step S3020), cancels the stored end state, and erases the warning screen image 90 (step S3030). Thus, even when the user replaces the toner cartridge without operating OK button 94, warning screen image 90 is automatically erased. When the user operates OK button 94 and the warning screen image 90 has already been erased, the process step of erasing the warning screen image 90 does not cause any change of display.

When the remaining amount of toner becomes low as the printing process such as copy-printing is executed, image forming apparatus 100 repeats the above-described operation.

<Replacement of Toner Cartridge when the Power is Off>

When the near-end state is detected, image forming apparatus 100 displays the message 70 shown in FIG. 7 on touch-panel display 132 (step S1060 of FIG. 3). Assume that noticing the message, the user prepares a new toner cartridge (brand-new toner cartridge) and exchanges to the prepared brand-new toner cartridge after once turning the power off. When the power is again turned on, image forming apparatus 100 determines whether the toner was in the end state before power off. Here, it was the near-end state before the power off. Therefore, image forming apparatus 100 determines that it was not in the end state before power off (NO at step S1000). Image forming apparatus 100 executes the process for comparing the mounted toner cartridge (step S1010), and if it is determined that while the power was off, a new toner cartridge was mounted (NO at step S1020), the apparatus is set to the operation inhibited state (step S1100 of FIG. 4). Here, control unit 160 causes touch-panel display 132 to display the warning screen image urging that the toner cartridge that has been used (the one used before replacement) should be placed back, instead of the newly mounted toner cartridge (step S1110).

Assume that the user turns the power off and places back the toner cartridge that has been used, in accordance with the message on warning screen image 80. When the power is turned on, image forming apparatus 100 determines whether the toner was in the end state before power off. Here, it was the near-end state before the power off. Therefore, image forming apparatus 100 determines that it was not in the end state before power off (NO at step S1000). Image forming apparatus 100 executes the process for comparing the mounted toner cartridge (step S1010), and if it is determined that while the power was off, the toner cartridge that had been used was returned (YES at step S1020), whether the apparatus is in the operation inhibited state or not is determined. Since the operation inhibited state is not yet cancelled, image forming apparatus 100 determines that it is in the operation inhibited state (YES at step S1030). Image forming apparatus 100 (control unit 160) cancels the operation inhibited state, and erases the warning screen image 80 (step S1150). Here, since the warning screen image 80 is not displayed, execution of the process step to erase warning screen image 80 does not cause any change of the screen image.

When the toner cartridge that has been used is thus used continuously and when the toner in the toner cartridge is used up, toner remaining amount detecting unit 180 detects the end state. Toner remaining amount detecting unit 180 outputs a signal indicating detection of the end state to control unit 160. Detecting the end state from the signal output from toner remaining amount detecting unit 180 (NO at step S1040 of FIG. 3), control unit 160 notifies the user that the toner is used up (step S1160). Further, when the end state is detected, control unit 160 stores the end state in RAM 166 or storage 168 (step S1160).

Assume that the user turns the power off and exchanges to the brand-new toner cartridge. When the power is turned on, image forming apparatus 100 determines whether the toner was in the end state before power off. Here, it was in the end state before the power off. Therefore, image forming apparatus 100 determines that it was the end state before power off (YES at step S1000). Image forming apparatus 100 executes the comparing process (step S1180), and if it is determined that the brand-new toner cartridge was mounted while the power was off (YES at step S1190), it generates identification information consisting of the identification number (for example, device number) of itself and a management serial number. Image forming apparatus 100 writes the generated identification information to the non-volatile memory of the toner cartridge (step S3000 of FIG. 6), and also writes the same identification information to storage 168 (step S3010). Image forming apparatus 100 recognizes the toner cartridge corresponding to the identification information written in storage 168 as the toner cartridge that is being used. When the process of writing the identification information ends, image forming apparatus resets the toner count (step S3020), cancels the stored end state, and erases the warning screen image 90 (step S3030). Here, since the warning screen image 90 is not displayed, execution of the process step to erase warning screen image 90 does not cause any change of the screen image.

When the remaining amount of toner becomes low as the printing process such as copy-printing is executed, image forming apparatus 100 repeats the above-described operation.

[Functions and Effects]

As is apparent from the description above, use of image forming apparatus 100 in accordance with the present embodiment attains the following effects.

A toner cartridge containing toner used at the time of image formation is detachably mounted on image forming apparatus 100. Image forming apparatus 100 stores identification information of the mounted toner cartridge in storage 168 and thereby recognizes the toner cartridge that is currently being used. Image forming apparatus 100 detects remaining amount of toner in the mounted toner cartridge, and if removal/mounting of a toner cartridge is detected while the remaining amount of toner is not lower than a prescribed value (while not a small amount of toner remains), whether or not the newly mounted toner cartridge is the one that corresponds to the identification information stored in storage 168 is determined. Specifically, when the toner cartridge is removed while the toner remains therein and a toner cartridge is mounted, image forming apparatus 100 determines whether or not the newly mounted toner cartridge is the one that has been used. If the newly mounted toner cartridge is not the toner cartridge that has been used, image forming apparatus 100 controls image forming unit 120 such that image forming operation is inhibited. When the remaining toner amount reaches the end state, image forming apparatus 100 issues a notice urging replacement of the toner cartridge.

In this manner, if the toner cartridge is removed while the toner remaining amount is not the end state, that is, while the toner still remains, and another toner cartridge (for example, a brand-new toner cartridge) is mounted, the image forming operation is inhibited. When the toner cartridge is replaced, image formation is impossible unless the toner of the cartridge that has been used by that time is used up. Thus, replacement of toner cartridge before using up the toner can easily be prevented. Further, in image forming apparatus 100, mechanical lock mechanism is not used to prevent replacement of the toner cartridge before using up the toner. Therefore, image forming apparatus 100 enables efficient use of resource with a simple structure and at a low cost.

### Second Embodiment

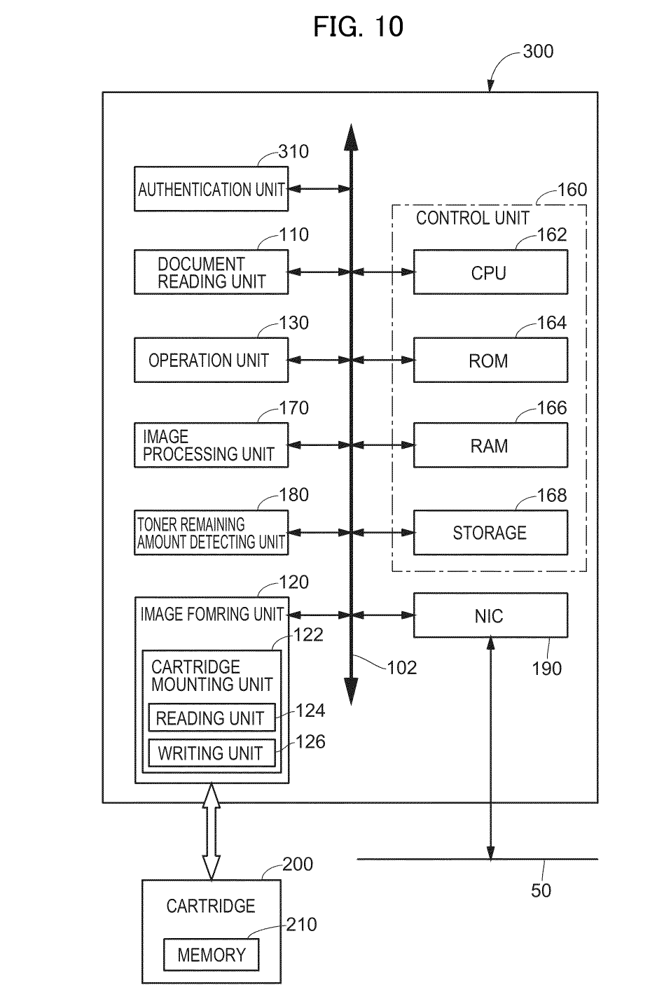

Referring to FIG. 10, an image forming apparatus 300 in accordance with the present embodiment differs from image forming apparatus 100 in accordance with the first embodiment in that it includes an authentication unit 310 authenticating a user having an administrator authority. Except for this point, the image forming apparatus has the same configuration.

As described above, from the viewpoint of efficient resource use, it is desirable to replace the toner cartridge after using up the toner. It is possible, however, that some defect or malfunction (such as failure of toner supply) of the toner cartridge makes replacement before using up the toner inevitable. In the present embodiment, the operation inhibited state can be cancelled by an operation by a user having an administrator authority. Specifically, a user having the administrator authority can operate a setting menu that allows replacement of toner cartridge, and hence, by changing the setting on the setting menu, replacement of the toner cartridge of which toner is not yet used up is allowed.

[Software Configuration]

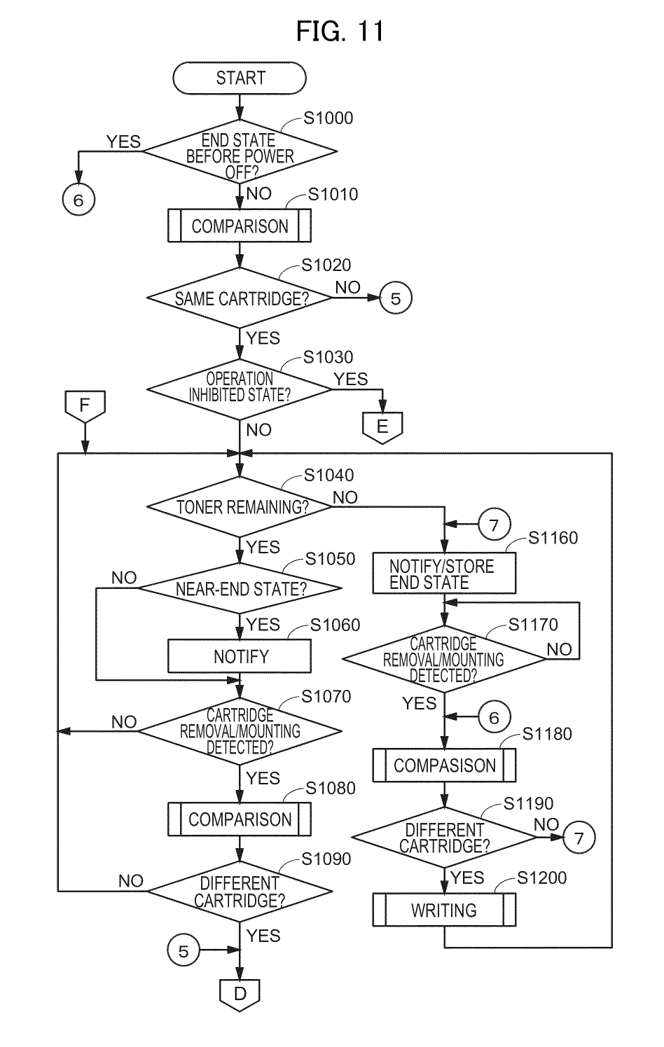

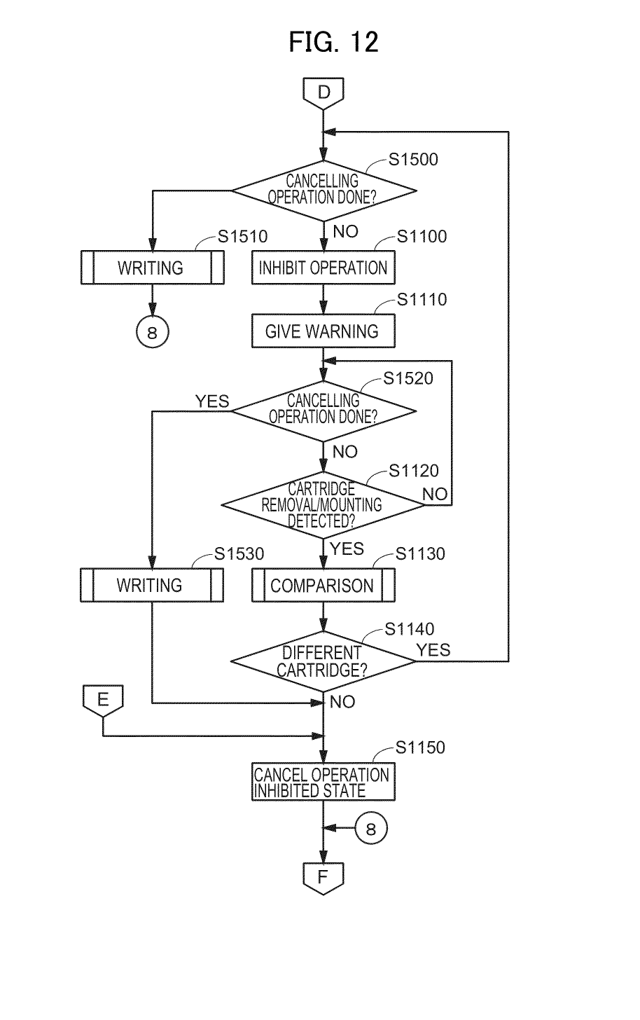

In image forming apparatus 300 in accordance with the present embodiment, a program shown in FIGS. 11 and 12 is executed in place of the program shown in FIGS. 3 and 4. Referring to FIG. 12, in image forming apparatus 300 in accordance with the present embodiment, process steps other than steps S1500, 1510, 1520 and 1530 are the same as those executed by the computer program shown in FIGS. 3 and 4. In the following, different portions will be described.

Referring to FIG. 12, the program includes: a step S1500, executed if it is determined at step S1020 or S1090 shown in FIG. 11 that the mounted toner cartridge is different from the toner cartridge that has been used, of determining whether or not a cancelling operation for cancelling the operation inhibited state is done by a user having the administration authority, and branching the flow of control depending on the result of determination; a step S1510, executed if it is determined at step S1500 that the cancelling operation has been done, of executing a writing process; a step S1520, executed after step S1110, of determining whether or not a cancelling operation for cancelling the operation inhibited state is done by a user having the administration authority, and branching the flow of control depending on the result of determination; and a step S1530, executed if it is determined at step S1520 that the cancelling operation has been done, of executing a writing process.

If it is determined at step S1500 that the cancelling operation is not done, the control proceeds to step S1100. If it is determined at step S1520 that the cancelling operation is not done, the control proceeds to step S1120. When the process at step S1510 ends, the control returns to step S1040 of FIG. 11. When the process at step S1530 ends, the control proceeds to step S1150. At steps S1510 and S1530, the same process as step S1200 of FIG. 3 is executed.

[Operation]

Image forming apparatus 300 in accordance with the present embodiment operates in the following manner. Except for the cancelling operation executed by the user having the administrator authority, the operation is the same as that of image forming apparatus 100 in accordance with the first embodiment above. Therefore, detailed description of similar operations will not be repeated.

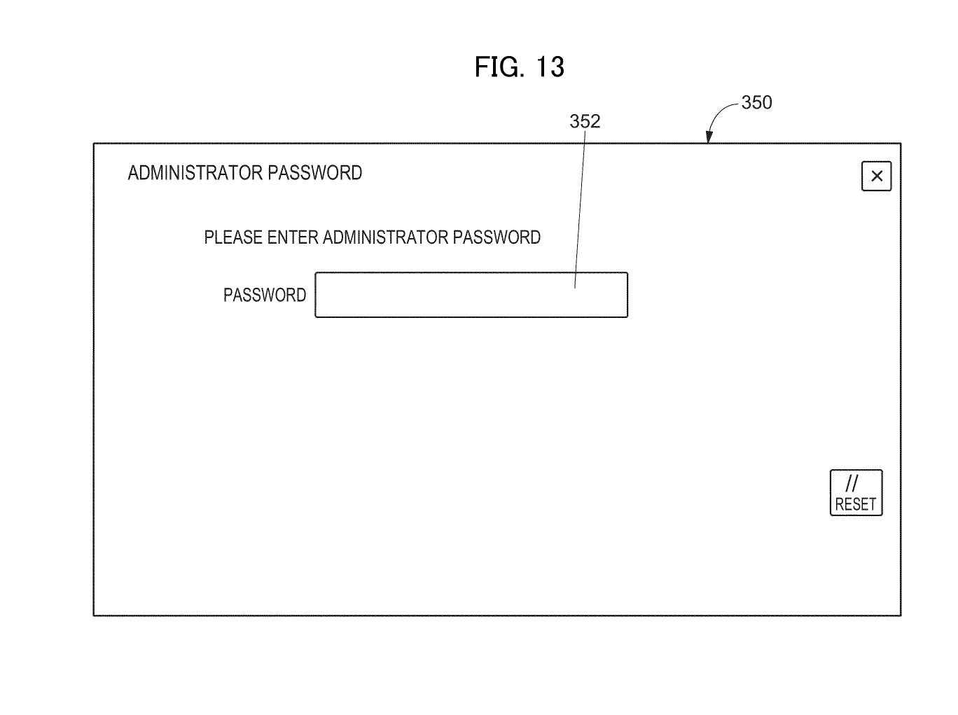

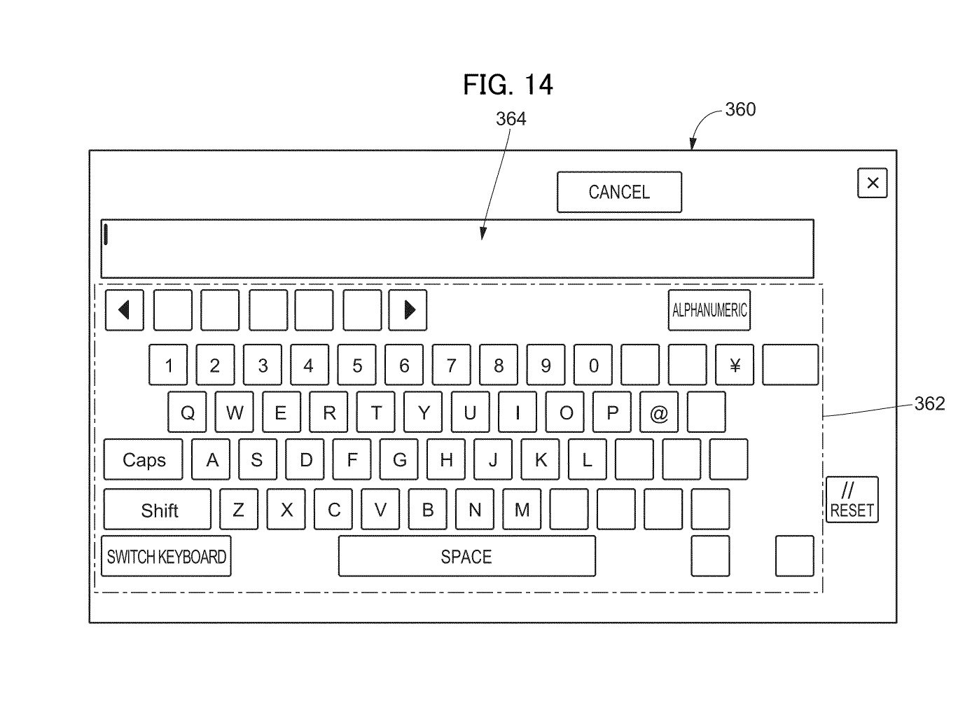

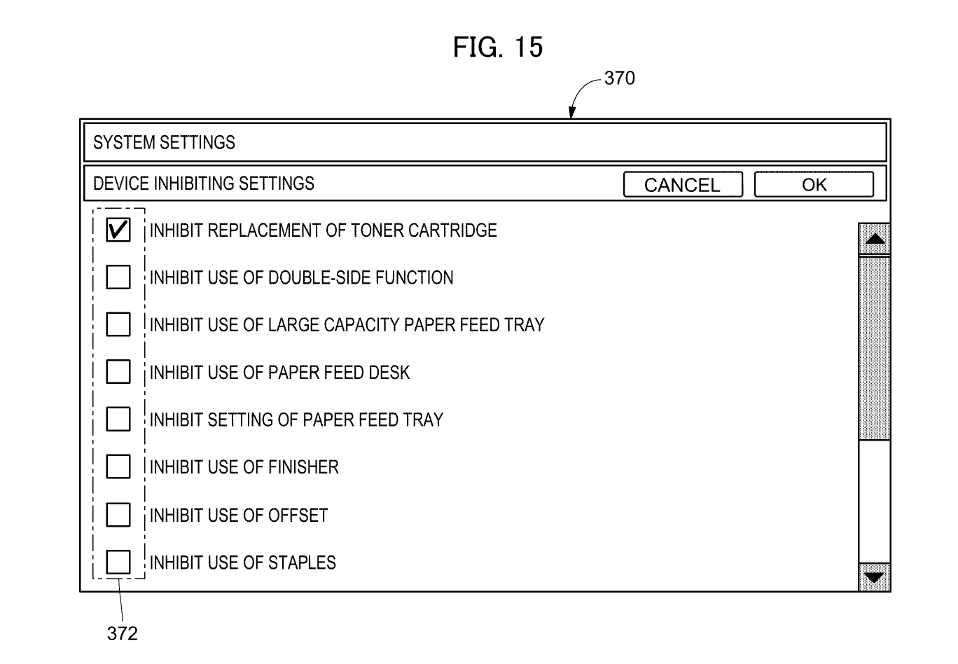

At the time of authentication of a user having the administrator authority, image forming apparatus 300 displays an authentication screen image 350 for authenticating the user having the administrator authority, shown in FIG. 13. Referring to FIG. 13, authentication screen image 350 for authenticating the user having the administrator authority has a password input field 352 for entering a password. When a touch by the user of password input field 352 is detected, image forming apparatus 300 displays a password input screen image 360 shown in FIG. 14 on touch-panel display 132. Referring to FIG. 14, password input screen image 360 includes an area 362 having a keyboard allowing input of characters, numerals and symbols, and an area 364 for displaying the characters and the like input through the keyboard. The characters and the like displayed on area 364 are displayed as the password in password input field 352 of authentication screen image 350 for authenticating the user having the administrator authority. When the user having the administrator authority is authenticated by authentication unit 310, image forming apparatus 300 displays a setting menu (system setting screen image 370) shown in FIG. 15 on touch-panel display 132. Referring to FIG. 15, system setting screen image 370 includes check boxes 372 to be checked if corresponding settings of image forming apparatus 300 are to be inhibited. If a check box inhibiting replacement of toner cartridge is cancelled, the setting for inhibiting replacement of toner cartridge becomes invalid and, therefore, if the operation of image forming apparatus 300 has been inhibited, the operation inhibited state is cancelled.

If such an operation is or has been done by a user having the administrator authority, image forming apparatus 300 determines that the cancelling operation has been done (steps S1500 and S1520 shown in FIG. 12). If image forming apparatus 300 has been in the operation inhibited state, the apparatus cancels the operation inhibited state (step S1150). If image forming apparatus 300 is not in the operation inhibited state, the apparatus is not set to the operation inhibited state, and replacement of a toner, of which toner is not yet used up, is permitted.

[Functions and Effects]

Image forming apparatus 300 in accordance with the present embodiment attains the following effects.

As in the first embodiment described above, image forming apparatus prevents replacement of a toner cartridge of which toner is not yet used up. Therefore, efficient use of resources can easily be attained. Further, if replacement of a toner cartridge becomes necessary before the toner contained therein is used up because of some failure or defect of the toner cartridge, setting to permit replacement of the toner cartridge before using up the toner is possible by an operation of the user having the administrator authority.

In a configuration using a mechanical lock mechanism for inhibiting replacement of a toner cartridge before using up the toner, it is necessary to cancel the mechanical lock mechanism by a service person, if it becomes necessary by a failure or defect of the toner cartridge to replace the toner cartridge before using up the toner.

In the present embodiment, the operation inhibited state can be cancelled by an operation of a user having the administrator authority. Therefore, as compared with the cancellation of mechanical lock mechanism by a service person, immediate assistance is possible.

### Third Embodiment

The image forming apparatus in accordance with the present embodiment differs from image forming apparatus 300 in accordance with the second embodiment in that replacement of toner cartridge is inhibited as a default setting on the system setting screen image 370 shown in FIG. 15. Except for this point, the image forming apparatus has the same configuration.

Referring to FIG. 15, in the present embodiment also, if the check box inhibiting replacement of toner cartridge is cancelled, the setting for inhibiting replacement of toner cartridge becomes invalid. Thus, replacement of a toner cartridge before the toner is used up is permitted. It is possible for a user to replace the toner cartridge before using up the toner.

In the present embodiment, after a toner cartridge is replaced, the image forming apparatus automatically inhibits the permitted setting. Specifically, when the check inhibiting replacement of a toner cartridge is cancelled and thereafter replacement of the toner cartridge is detected, the image forming apparatus automatically checks the check box setting inhibition of replacement of the toner cartridge on system setting screen image 370.

### Fourth Embodiment

The image forming apparatus in accordance with the present embodiment differs from image forming apparatus 300 in accordance with the second embodiment in that when a toner cartridge is replaced before the toner is used up and the operation is inhibited, the image forming apparatus notifies a service center of the fact through a network. Except for this point, the image forming apparatus has the same configuration.

When a user contacts the service center by, for example, a telephone call, the service center can remotely cancel the operation inhibited state. Therefore, necessary steps can easily be taken even if replacement of a toner cartridge becomes necessary before the toner is used up because of some failure or defect of the toner cartridge and the user having the administrator authority should be absent.

(Modifications)

Though an example in which the present invention is applied to an MFP as an example of image forming apparatus has been described above, the present invention is not limited to such embodiments. The image forming apparatus may be any apparatus other than the MFP, provided that it has the printing function. By way of example, the apparatus may be a copy machine, a printer or the like.

Though an image forming apparatus having the so-called laser type (electrophotographic) printing function using laser light for exposure has been described in the embodiments above, the present invention is not limited to such embodiments. The image forming apparatus may have a different type printing function.

In the embodiments above, an example has been described in which a toner cartridge containing toner is used as a consumable component. The preset invention, however, is not limited to such embodiments. The consumable component used may not be a toner cartridge. By way of example, it may be an ink cartridge containing ink. Such an ink cartridge is used mounted on an image forming apparatus having, for example, ink-jet type printing function.

In the embodiments above, an example has been described in which a warning screen image is displayed on the touch-panel display when the image forming apparatus is in the operation inhibited state, urging the user to return the toner cartridge that has been used. The present invention, however, is not limited to such embodiments. By way of example, such a warning may be given by a method other than displaying the warning screen image. For instance, warning by sound or lamp indication may be possible. Alternatively, a configuration not giving such a warning may be used. For instance, the display on the touch-panel display may be erased if the image forming apparatus is in the operation inhibited state.

In the embodiments above, an example has been described in which the identification information consisting of the identification number (for example, device number such as the manufacturer's serial number) unique to the image forming apparatus and the serial number of the toner cartridge managed by the image forming apparatus is generated by the image forming apparatus and the generated identification information is used as the identification information of the toner cartridge. The present invention, however, is not limited to such embodiments. The identification information of toner cartridge may be any identification information other than the one described above, provided that the toner cartridge can uniquely be identified.

In the embodiments above, an example has been described in which the identification information generated by the image forming apparatus is written to the non-volatile memory of the toner cartridge. The present invention, however, is not limited to such embodiments. By way of example, individual identification information may be stored in the non-volatile memory of the cartridge. The individual identification information may be the serial No. unique to the cartridge. By storing the number in the storage or the like of the image forming apparatus and comparing it with the individual identification information of the mounted cartridge when the power is turned on or when opening/closing operation of the cover is detected, replacement of the cartridge may be detected. In the embodiments above, the cartridge mounting unit of image forming apparatus may have a non-volatile memory and the identification information of the toner cartridge may be stored in the memory, in place of the storage such as the hard disk.

In the embodiments above, an example in which the remaining amount of toner is detected by determining the toner count in accordance with the number of prints has been described. The present invention, however, is not limited to such embodiments. The remaining amount of toner may be detected by any conventional method. By way of example, the near-end state or end state of the toner remaining amount may be detected based on an output of a sensor detecting the amount of toner.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming apparatus, comprising:
an image forming unit configured to form an image;
a mounting unit configured to detachably mount a consumable component containing a consumable supply used when an image is formed by said image forming unit;
a storage configured to store identification information for uniquely identifying said mounted consumable component;
a detecting unit configured to detect a remaining amount of said consumable supply in the mounted consumable component;
a determining unit, configured to obtain, responsive to a detection of removal and mounting of a consumable component while the remaining amount of said consumable supply is not lower than a prescribed value, from the mounted consumable component, the identification information of the mounted consumable component and to compare the obtained identification information with the identification information stored in said storage, and thereby to determine whether the mounted consumable component corresponds to the identification information stored in said storage; and
an inhibiting unit, configured to control said image forming unit such that an image forming operation is inhibited, responsive to a negative result of determination by said determining unit.

2. The image forming apparatus according to claim 1, further comprising:
a consumable component determining unit, configured to obtain, responsive to a detection of removal and mounting of a consumable component while the image forming operation is inhibited, the identification information from the mounted consumable component and to compare the obtained identification information with the identification information stored in the storage, and thereby to determine whether the mounted consumable component corresponds to the identification information stored in said storage; and
an executing unit, configured to selectively cancel or maintain the inhibited state, depending on the result of determination by said consumable component determining unit.

3. The image forming apparatus according to claim 1, further comprising:
a notifying unit, configured to give a notice urging replacement of the consumable component, when the remaining amount of said consumable supply becomes lower than the prescribed value.

4. The image forming apparatus according to claim 1, further comprising:
a display unit configured to display information; and
a display control unit configured to control said display unit such that responsive to said inhibiting unit inhibiting the image forming operation of said image forming unit, said display unit displays a warning message urging mounting of the consumable component corresponding to the identification information stored in said storage.

5. The image forming apparatus according to claim 1, further comprising:
an authentication unit, configured to execute an authentication process for a user having an administrator authority;
a receiving unit, configured to receive a cancelling operation for cancelling the image forming operation inhibited state, by the user having the administrator authority authenticated by said authentication unit; and
a cancelling unit, configured to cancel the image forming operation inhibited state, responsive to said receiving unit receiving said cancelling operation.

6. The image forming apparatus according to claim 5, further comprising
a setting unit configured to set whether the process by said inhibiting unit is to be executed or not; wherein
said receiving unit receives said cancelling operation of cancelling the image forming operation inhibited state, when a setting operation by the user having the administrator authority is received.

7. The image forming apparatus according to claim 6, further comprising:
a rewriting unit, configured to rewrite, responsive to cancellation of the image forming operation inhibited state by the reception of said cancelling operation, the identification information stored in said storage with the identification information of the mounted consumable component; and
a setting control unit, responsive to said rewriting unit rewriting the identification information, controlling setting of said setting unit such that the process by said inhibiting unit is executed.

8. The image forming apparatus according to claim 1, wherein said mounting unit includes a cartridge mounting unit configured to detachably mount a cartridge containing toner.

9. A method of operating an image forming apparatus including an image forming unit configured to form an image, a mounting unit configured to detachably mount a consumable component containing a consumable supply used when an image is formed by said image forming unit, and a storage configured to store identification information for uniquely identifying said mounted consumable component, comprising the steps of:
detecting a remaining amount of said consumable supply in the mounted consumable component;
in response to a detection of removal and mounting of a consumable component while the remaining amount of said consumable supply is not lower than a prescribed value, obtaining, from the mounted consumable component, the identification information of the mounted consumable component, and comparing the obtained identification information with the identification information stored in said storage, and thereby determining whether the mounted consumable component corresponds to the identification information stored in said storage; and
controlling said image forming unit such that an image forming operation is inhibited, in response to a negative result of determination at said determining step.
